(19) United States
(12) Patent Application Publication
(10) Pub. No.: US 2023/0094206 A1
(43) Pub. Date: Mar. 30, 2023

(54) IMAGE PROCESSING METHOD AND APPARATUS, DEVICE, AND STORAGE MEDIUM

(71) Applicant: Tencent Technology (Shenzhen) Company Limited, Shenzhen (CN)

(72) Inventors: Shaohao LU, Shenzhen (CN); Yi HU, Shenzhen (CN); Ke YAN, Shenzhen (CN); Junlong DU, Shenzhen (CN); Cheng ZHU, Shenzhen (CN); Xiaowei GUO, Shenzhen (CN)

(73) Assignee: Tencent Technology (Shenzhen) Company Limited, Shenzhen (CN)

(21) Appl. No.: 17/991,442

(22) Filed: Nov. 21, 2022

Related U.S. Application Data
(63) Continuation of application No. PCT/CN2022/078278, filed on Feb. 28, 2022.

(30) Foreign Application Priority Data
Mar. 5, 2021 (CN) 202110246305.0

(51) Int. Cl. G06V 10/774; G06T 5/00; G06V 10/77; G06T 5/50; G06V 10/776

(52) U.S. Cl. CPC G06V 10/774; G06T 5/002; G06T 5/50; G06V 10/776; G06V 10/7715; G06T 2207/20081; G06T 2207/20084

(57) ABSTRACT

An image processing method and apparatus, a device, and a non-transitory computer-readable storage medium are provided. In the method, a first feature map is obtained based on feature-encoding of an original image. A second feature map of the original image is obtained based on the first feature map. The second feature map includes noise information to be superimposed on the original image. A third feature map of the original image is obtained based on the first feature map. The third feature map includes different feature values. Each feature value represents a relative importance of an image feature at a position corresponding to the respective feature value. A noise image is generated based on the second feature map and the third feature map. The original image and the noise image are superimposed, to obtain a first adversarial example image

### RELATED APPLICATIONS

The present application is a continuation of International Application No. PCT/CN2022/078278, entitled “IMAGE PROCESSING METHOD AND APPARATUS, AND DEVICE AND STORAGE MEDIUM” and filed on Feb. 28, 2022, which claims priority to Chinese Patent Application No. 202110246305.0, entitled “IMAGE PROCESSING METHOD AND APPARATUS, DEVICE, AND STORAGE MEDIUM” and filed on Mar. 05, 2021. The entire disclosures of the prior applications are hereby incorporated by reference in their entirety.

### FIELD OF THE TECHNOLOGY

This application relates to the field of image processing technologies, including to an image processing method and apparatus, a device, and a storage medium.

### BACKGROUND OF THE DISCLOSURE

Generally, image recognition models are built based on deep learning, and methods of using the disadvantages of deep learning to negatively affect the image recognition ability of an image recognition model are collectively called “adversarial attacks”, that is, an image recognition task of the image recognition model based on deep learning can be invalidated after noise that is difficult for human eyes to recognize is added to an image. In other words, an objective of the adversarial attacks is to add disturbances that are difficult to be detected by human eyes to the original image, so that recognition results outputted by the model are inconsistent with the actual classification of the original image. An image to which noise is added and which appears to be consistent with the original image to the human eyes may be called an adversarial example.

Current adversarial attacks cannot achieve an effective attack effect. Therefore, how to perform image processing to generate high-quality adversarial examples has become a difficult problem to be solved urgently by the technical personnel skilled in the art.

### SUMMARY

Embodiments of this disclosure provide an image processing method and apparatus, a device, and a non-transitory computer-readable storage medium.

According to one aspect, an image processing method is provided. In the method, a first feature map is obtained based on feature-encoding of an original image. A second feature map of the original image is obtained based on the first feature map. The second feature map includes noise information to be superimposed on the original image. A third feature map of the original image is obtained based on the first feature map. The third feature map includes different feature values. Each feature value represents a relative importance of an image feature at a position corresponding to the respective feature value. A noise image is generated based on the second feature map and the third feature map. The original image and the noise image are superimposed, to obtain a first adversarial example image

According to another aspect, an image processing apparatus is provided. The image processing apparatus includes processing circuitry that is configured to obtain a first feature map based on feature-encoding of an original image, and obtain a second feature map of the original image based on the first feature map. The second feature map includes noise information to be superimposed on the original image. The processing circuitry is configured to obtain a third feature map of the original image based on the first feature map. The third feature map includes different feature values. Each feature value represents a relative importance of an image feature at a position corresponding to the respective feature value. The processing circuitry is configured to generate a noise image based on the second feature map and the third feature map. Further, the processing circuitry. Further, the processing circuitry is configured to superimpose the original image and the noise image, to obtain a first adversarial example image.

According to another aspect, a computer device is provided, including a processor and a memory, the memory storing at least one piece of program code, the at least one piece of program code being loaded and executed by the processor, to implement the foregoing image processing method.

According to another aspect, a non-transitory computer-readable storage medium is provided. The non-transitory computer-readable storage medium stores instructions which when executed by a processor cause the processor to implement the foregoing image processing method.

According to another aspect, a computer program product or a computer program is provided, including computer program code, the computer program code being stored in a computer-readable storage medium, a processor of a computer device reading the computer program code from the computer-readable storage medium, and the processor executing the computer program code, to cause the computer device to implement the foregoing image processing method.

### BRIEF DESCRIPTION OF THE DRAWINGS

FIG. 1 is a schematic diagram of an implementation environment involved in an image processing method according to an embodiment of this disclosure.

FIG. 2 is a flowchart of an image processing method according to an embodiment of this disclosure.

FIG. 3 is a schematic structural diagram of an adversarial attack network according to an embodiment of this disclosure.

FIG. 4 is a schematic structural diagram of another adversarial attack network according to an embodiment of this disclosure.

FIG. 5 is a schematic structural diagram of a residual block (ResBlock) according to an embodiment of this disclosure.

FIG. 6 is a flowchart of another image processing method according to an embodiment of this disclosure.

FIG. 7 is a flowchart of another image processing method according to an embodiment of this disclosure.

FIG. 8 is a schematic diagram of a training process of an adversarial attack network according to an embodiment of this disclosure.

FIG. 9 is a schematic diagram of an angular-modular isolation and optimization loss function according to an embodiment of this disclosure.

FIG. 10 is a schematic diagram of an adversarial attack result according to an embodiment of this disclosure.

FIG. 11 is a schematic diagram of another adversarial attack result according to an embodiment of this disclosure.

FIG. 12 is a schematic diagram of another adversarial attack result according to an embodiment of this disclosure.

FIG. 13 is a schematic diagram of another adversarial attack result according to an embodiment of this disclosure.

FIG. 14 is a schematic diagram of another adversarial attack result according to an embodiment of this disclosure.

FIG. 15 is a schematic structural diagram of an image processing apparatus according to an embodiment of this disclosure.

FIG. 16 is a schematic structural diagram of a computer device according to an embodiment of this disclosure.

FIG. 17 is a schematic structural diagram of another computer device according to an embodiment of this disclosure.

### DESCRIPTION OF EMBODIMENTS

To make objectives, technical solutions, and advantages of this disclosure clearer, the following further describes in further detail exemplary implementations of this disclosure with reference to the accompanying drawings.

The terms “first”, “second”, and the like in this disclosure are used for distinguishing between same items or similar items of which effects and functions are basically the same. The “first”, “second”, and “n^{th}” do not have a dependency relationship in logic or time sequence, and a quantity and an execution order thereof are not limited. It is to be understood that, although terms such as “first” and “second” are used to describe various elements in the following description, these elements are not to be limited to these terms.

These terms are merely used for distinguishing one element from another element. For example, a first element may be referred to as a second element, and similarly, a second element may be referred to as a first element without departing from the scope of the various examples. Both the first element and the second element are elements, and in some cases, the first element and the second element are separate and different elements.

“At least one” means one or more, for example, “at least one element” includes: one element, two elements, three elements and any other integral quantity of elements whose quantity is greater than or equal to one. “At least two” means two or more, for example, “at least two elements” includes: two elements, three elements and any other integral quantity of elements whose quantity is greater than or equal to two.

The related art uses a method based on search or optimization for adversarial attacks. The method based on search or optimization involves a plurality of forward operations and calculates gradients when generating an adversarial example (or adversarial example image), so as to search for a disturbance that invalidates the recognition task of the image recognition model in a certain search space. As a result, the generation of one adversarial example requires consumption of a large amount of time. In a case of a large number of pictures, the time required for this adversarial attack method may be unacceptable and the timeliness is poor. To address this problem, a method based on a generative adversarial network is proposed. However, the training of the generative adversarial network in a game with a generator and a discriminator, which makes the generated disturbance unstable, may lead to an unstable attack effect.

The image processing solution provided in the embodiments of this disclosure relates to the deep residual network (ResNet) in machine learning.

The depth of the neural network is important to its own performance, so in an ideal situation, as long as the neural network is not overfitting, the depth of the neural network should be as deep as possible. However, an optimization problem is encountered when training the neural network, that is, with the continuous increase of the depth of the neural network, the gradient is more likely to vanish (gradient vanishing), which makes it difficult to optimize the model, but leads to a decline of the accuracy of the neural network. In other words, in a case that the depth of the neural network is continuously increased, there is a problem of degradation, that is, the accuracy rises first and then reaches saturation, and then the accuracy declines if the depth is continuously increased.

Therefore, in a case that the number of network layers of the neural network reaches a certain number, the performance of the neural network is saturated. If the number of network layers continues to increase, the performance of the neural network starts to become degraded. However, this degradation is not caused by overfitting, because both the training accuracy and the testing accuracy are declining, which indicates that after the neural network reaches a certain depth, it is difficult to train the neural network. The emergence of the ResNet is to alleviate the performance degradation problem after the depth of the network becomes larger. The ResNet proposes a deep residual learning (DRL) framework to alleviate the performance degradation problem caused by the increase of the depth.

Assuming that a relatively shallow network reaches the accuracy of saturation, several identity mapping layers are added behind this network, and at least the error does not increase, that is, the deeper network should not bring about an increase in the error of the training set. The idea of using an identity mapping to directly transfer the output of the previous layer to the subsequent layer mentioned herein is an inspiration source of the ResNet.

For more explanations of the ResNet, refer to the following description.

Some key terms or abbreviations that may be involved in the embodiments of this disclosure are described below:

In adversarial attacks, after noise that is difficult for human eyes to recognize is added to an image (also called original image), an image recognition task of the image recognition model based on deep learning is invalidated in some examples. That is to say, an objective of the adversarial attacks is to add disturbances that are difficult to be detected by human eyes to the original image, so that recognition results of the image recognition model are inconsistent with the actual classification of the original image. An image to which noise is added and which appears to be consistent with the original image to the human eyes may be called an adversarial example or an attack image.

In other words, the original image and the adversarial example are visually consistent, and they have visual consistency, which makes it impossible for human eyes to distinguish the subtle differences between them when observing the two images. That is, “visually consistent” means: after adding disturbances that are difficult to be detected by human eyes to the original image to obtain the adversarial example, the original image and the adversarial example appear to be consistent to human eyes, and human eyes cannot distinguish the subtle differences between them.

Feature-encoding includes a process of extracting a first feature map of the original image through a feature encoder in the adversarial attack network, that is, the original image is inputted into the feature encoder of the adversarial attack network, the original image is encoded by the convolutional layer and the ResBlock in the feature encoder, and the first feature map is finally outputted.

Feature-decoding includes a process of recovering a new feature map with the same size as the original image from the first feature map obtained through encoding by the feature encoder through the feature decoder in the adversarial attack network. For the same first feature map, different output results are obtained when inputted to feature encoders with different parameters. For example, the first feature map is inputted to a first feature decoder (e.g., noise decoder), and a second feature map is outputted; and the first feature map is inputted to a second feature decoder (e.g., salient region decoder), and a third feature map is outputted.

An exemplary implementation environment involved in an image processing method provided in an embodiment of this disclosure is described below.

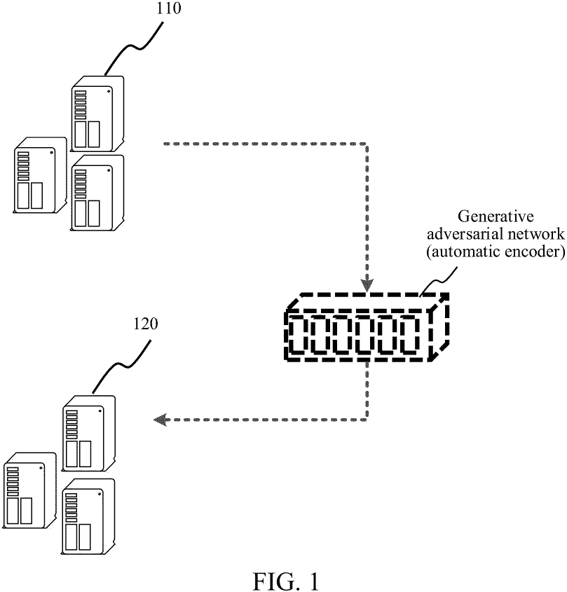

Referring to FIG. 1, the implementation environment includes: a training device 110 and an application device 120.

During the training stage, the training device 110 is configured to perform end-to-end training on an initial adversarial attack network to obtain an adversarial attack network for adversarial attacks (also called automatic encoder), based on a defined loss function. During the application stage, the application device 120 may use the automatic encoder to generate an adversarial example of an inputted original image. In other words, during the training stage, the automatic encoder configured to generate the adversarial example is obtained through the end-to-end training; and correspondingly, during the application stage, for an inputted original image, an adversarial example appearing to be consistent with the original image to human eyes is generated through the automatic encoder, and then is configured to attack an image recognition model.

Accordingly, the image processing solution provided in an embodiment of this disclosure uses a trained automatic encoder to generate an image disturbance (obtain a noise image), and then superimposes the generated image disturbance (e.g., the noise image) on the original image to generate the adversarial example, thereby causing the image recognition model to mistakenly recognize the adversarial example. In this way, a relatively high-quality (can deceive the image recognition model successfully) adversarial example is obtained, so that the high-quality adversarial example is used to further train the image recognition model, and the image recognition model may learn how to recognize the adversarial example with high confusability, thereby obtaining an image recognition model with better performance, to better adapt to various image recognition and image classification tasks.

In example, the training device 110 and the application device 120 are computer devices, for example, the computer device is a terminal or a server. In some embodiments, the server may be an independent physical server, or may be a server cluster or a distributed system formed by a plurality of physical servers, or may be a cloud server that provides a basic cloud computing service such as a cloud service, a cloud database, cloud computing, a cloud function, cloud storage, a network service, cloud communication, a middleware service, a domain name service, a security service, a content delivery network (CDN), big data, and an artificial intelligence platform. The terminal may be a smartphone, a tablet computer, a notebook computer, a desktop computer, a smart speaker, a smart watch, or the like, but is not limited thereto. The terminal and the server may be directly or indirectly connected in a wired or wireless communication manner. This is not limited in this disclosure.

In another embodiment, the training device 110 and the application device 120 are the same device. Alternatively, the training device 110 and the application device 120 are different devices. In addition, in a case that the training device 110 and the application device 120 are different devices, the training device 110 and the application device 120 may be the same or different types of devices. For example, both the training device 110 and the application device 120 are terminals or the training device 110 is a server and the application device 120 is a terminal. This is not limited in this disclosure.

An image processing solution provided in an embodiment of this disclosure is described below by using the following implementations.

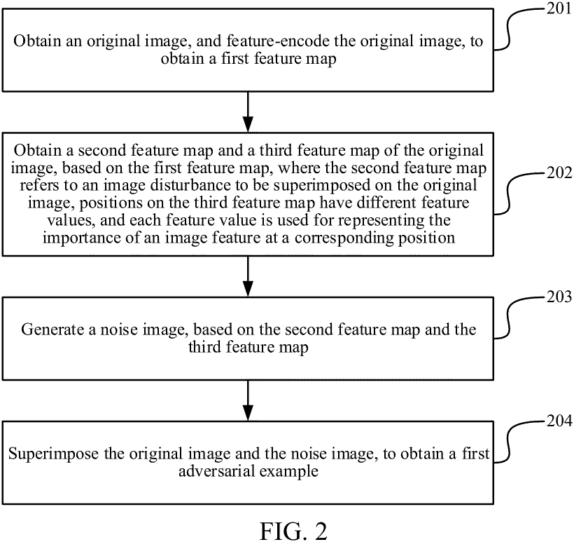

FIG. 2 is a flowchart of an image processing method according to an embodiment of this disclosure. Referring to FIG. 2, during the application stage, the method provided in this embodiment of this disclosure is performed by the application device 120 introduced in the foregoing implementation environment. Using an example that the application device 120 is a server, the method flow includes:

In step 201, a server obtains an original image, and feature-encodes the original image, to obtain a first feature map. In an example, a first feature map is obtained based on feature-encoding of an original image.

The foregoing step 201 is an example of a feature-encoding process of the server feature-encoding the original image to obtain the first feature map, and may be further regarded as a feature extraction process for the first feature map of the original image.

In an example, the original image is a red green blue (RGB) image, and the RGB image is a type of three-channel image; or, the original image is a single-channel image (e.g., a grayscale image). Types of the original image are not specifically limited in the embodiments of this disclosure.

In an example, the original image refers to an image including people and things (e.g., animals or plants). This is not limited in this disclosure. The original image is denoted by the symbol I in this embodiment of this disclosure.

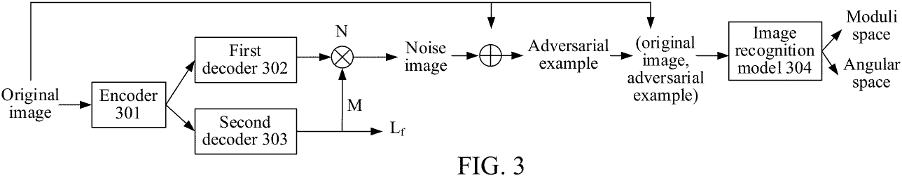

In some embodiments, feature-encoding an original image, to obtain a first feature map includes, but is not limited to, the following methods: inputting the original image into a feature encoder 301 of an adversarial attack network shown in FIG. 3 for feature-encoding processing, to obtain the first feature map, where the feature-encoding is further called feature extraction, and a size of the first feature map is less than a size of the original image.

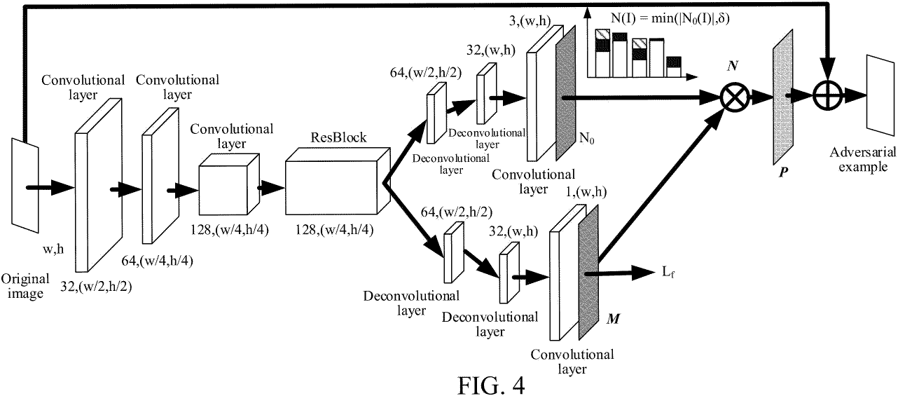

In an example, referring to FIG. 4, the feature encoder 301 uses a convolutional neural network, including a convolutional layer and a ResBlock. The ResBlock is located after the convolutional layer in connection order, that is to say, a feature map outputted from the convolutional layer is inputted into the ResBlock as an input signal for processing. Exemplarily, as shown in FIG. 4, the feature encoder 301 includes a plurality of convolutional layers connected in order and a plurality of ResBlocks connected in order, for example, three convolutional layers and six ResBlocks are included. This is not limited in this disclosure. In addition, sizes of convolution kernels of the foregoing plurality of convolutional layers are the same or different. This is not limited in this disclosure either.

Taking a structure of the feature encoder shown in FIG. 4 as an example, assuming that an input size of the original image is w*h and the number of channels is 3, after passing the first convolutional layer, a width (w) and a height (h) of the original image become ½ of the original width and height, and the number of channels changes from 3 to 32, forming a w/2*h/2*32 feature map; after passing the second convolutional layer, a width (w) and a height (h) of the original image become ¼ of the original width and height, and the number of channels changes from 32 to 64, forming a w/4*h/4*64 feature map; after passing the third convolutional layer, a width (w) and a height (h) of the original image become ¼ of the original width and height, and the number of channels changes from 64 to 128, forming a w/4*h/4* 128 feature map; then, the feature map passes a sub-network composed of six ResBlocks to generate a new feature map. That is to say, after passing the six ResBlocks, a w/4*h/4* 128 first feature map is obtained. The first feature map is a feature map obtained after the original image is feature-encoded by the feature encoder 301.

Each ResBlock of the feature encoder may include an identity mapping layer and at least two convolutional layers, and the identity mapping of each ResBlock may point to an output end of the ResBlock from an input end of the ResBlock. Identity mapping, for any set A, if the mapping f:A→A is defined as f(a)=a, that is, it is specified that each element a in A corresponds to itself, and then f may be called an identity mapping on A.

Next, a deep ResNet is described in detail.

It is assumed that an input of a certain neural network is x, an expected network layer relationship is mapped to H(x), and the stacked nonlinear layer is fitted with another mapping F(x)= H(x)-x, so the original mapping H(x) becomes F(x)+x. It is assumed that it is easier to optimize the residual mapping F(x) than the original mapping H(x). If the residual mapping F(x) is first obtained, then the original mapping is F(x)+x, and F(x)+x is realized by Shortcut connection.

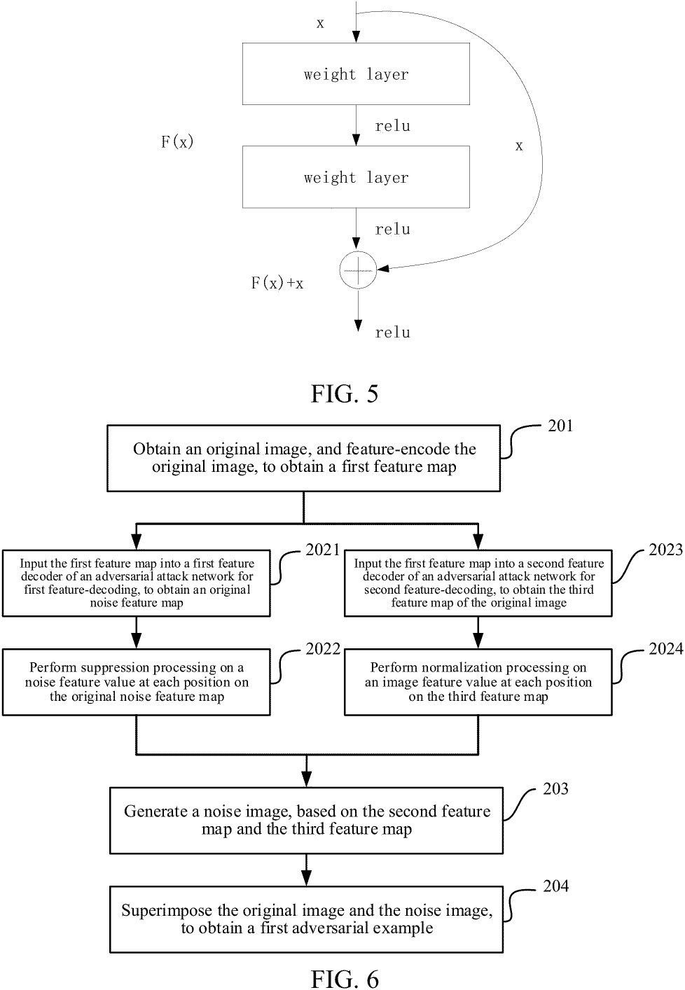

FIG. 5 shows a schematic structural diagram of an exemplary ResBlock. As shown in FIG. 5, each ResBlock of the deep ResNet may include an identity mapping and at least two convolutional layers. An identity mapping of a ResBlock may point to an output end of the ResBlock from an input end of the ResBlock.

That is, an identity mapping is added to convert the function H(x) originally to be learned to F(x)+x. Although the two expressions have the same effect, the difficulty of optimization is not the same. Through a reformulation, a problem is decomposed into a plurality of scale direct residual problems, which can have a good effect of optimizing the training. As shown in FIG. 5, the ResBlock is realized through Shortcut connection. Through the Shortcut connection, the input and the output of this ResBlock are superimposed. Without adding additional parameters and computation to the network, the training speed of the model may be greatly increased and the training effect may be improved. In addition, in a case that the number of layers of the model is increased, this simple structure can address the degradation problem well.

In other words, H(x) is a complex potential mapping of expectations, which is difficult to learn. If the input x is directly transferred to the output through the Shortcut connection in FIG. 5 as an initial result, the objective to be learned at this time is F(x)=H(x)-x. Therefore, the ResNet network is equivalent to changing the learning objective, no longer learning a complete output, but learning the difference between the optimal solution H(x) and the identity mapping x, that is, the residual mapping F(x). Shortcut originally means short cut, and includes a cross layer connection in this specification. In the ResNet network, the Shortcut connection has no weight. After x is transferred, each ResBlock only learns the residual mapping F(x). In addition, because the network is stable and easy to learn, and the performance is gradually improved with the increase of the depth of the network, in a case that the number of network layers is large enough, the residual mapping F(x)=H(x)-x is optimized, which makes it easy to optimize a complex nonlinear mapping H(x).

Based on the above description, it can be learned that, compared with a related direct-connected convolutional neural network, the ResNet network may include many bypass branches to directly connect the input to a subsequent layer, so that the subsequent layer directly learns the residual. This structure is called Shortcut connection. A related convolutional layer or fully connected layer more or less suffers from information loss and loss during information transmission, and the ResNet network solves this problem to some degree. Through directly bypassing the input to the output, the integrity of the information is protected, and the whole network only needs to learn such a part as the difference between the input and the output, which simplifies the learning objective and reduces the learning difficulty.

The first feature map obtained by the feature encoder 301 is inputted into a first feature decoder (also called noise decoder) 302 and a second feature decoder (also called salient region decoder) 303 of the adversarial attack network respectively. Referring to FIG. 3, the first feature decoder 302 and the second feature decoder 303 are structurally symmetric, and this specification proposes the concept of salient region, so the adversarial attack network is also called symmetric automatic encoder based on the salient region. Refer to step 202 below for details. Regarding a salient region, when facing any image (e.g., the original image), a human automatically processes the region of interest and selectively ignores the region of no interest due to the visual attention mechanism, and the foregoing region of interest may be called the salient region. The second feature decoder 303 may extract the salient region in the original image through a feature decoder.

In step 202, a server obtains a second feature map and a third feature map of the original image, based on the first feature map, where the second feature map refers to an image disturbance to be superimposed on the original image, positions on the third feature map have different feature values, and each feature value is used for representing the importance of an image feature at a corresponding position. In an example, a second feature map of the original image is obtained based on the first feature map, the second feature map including noise information to be superimposed on the original image. In an example, a third feature map of the original image is obtained based on the first feature map, the third feature map including different feature values, and each feature value representing a relative importance of an image feature at a position corresponding to the respective feature value.

The foregoing step 202 is that a server obtains a second feature map and a third feature map of the original image respectively, based on the first feature map.

In an example, step 202 is realized through the first feature decoder 302 and the second feature decoder 303 of the adversarial attack network shown in FIG. 3. For example, the first feature decoder 302 is used to obtain the second feature map, and the second feature decoder 303 is used to obtain the third feature map.

In an example, step 202 in FIG. 2 is replaced with steps 2021 to 2024 in FIG. 6.

In step 2021, the server inputs the first feature map into a first feature decoder of an adversarial attack network for first feature-decoding, to obtain an original noise feature map.

The foregoing step 2021 is that the server inputs the first feature map into a first feature decoder of an adversarial attack network, and feature-decodes the first feature map through the first feature decoder to output an original noise feature map.

In some embodiments, referring to FIG. 4, the first feature decoder 302 includes a deconvolutional layer and a convolutional layer, and the convolutional layer is located after the deconvolutional layer in connection order, that is to say, a feature map outputted from the deconvolutional layer is inputted into the convolutional layer as an input signal for convolution. For example, as shown in FIG. 4, the first feature decoder 302 includes two 3x3 deconvolutional layers and a 7x7 convolutional layer. The function of the deconvolutional layer is to transform an inputted feature map with a relatively small size into a feature map with a relatively large size.

As shown in FIG. 4, a feature map inputted by the first feature decoder 302 is a w/4*h/4* 128 first feature map obtained after encoding by the feature encoder 301, and the first feature map becomes a w/2*h/2*64 feature map after passing the first 3x3 deconvolutional layer; after passing the second 3x3 deconvolutional layer, the feature map becomes a w*h*32 feature map; and then after the feature map passes the 7x7 convolutional layer, a w*h*3 feature map is obtained, which is an original noise feature map. The original noise feature map is denoted by the symbol N₀ in this embodiment of this disclosure.

In step 2022, the server performs suppression processing on a noise feature value at each position on the original noise feature map to obtain a second feature map of the original image.

In an example, to avoid excessive noise, this embodiment of this disclosure imposes a limit on the noise feature value of the original noise feature map, thereby obtaining a second feature map. The performing suppression processing on a noise feature value at each position on the original noise feature map includes, but is not limited to: comparing the noise feature value at each position on the original noise feature map with a target threshold; and replacing, for any position on the original noise feature map, a noise feature value of the any position with the target threshold in response to the noise feature value of the any position being greater than the target threshold. A value range of the target threshold is consistent with a value range of the noise feature value.

In other words, for any position on the original noise feature map, a noise feature value of the position is replaced with the target threshold in a case that the noise feature value of the position is greater than the target threshold. The noise suppression process may be expressed as the following formula:

$$N \left(I\right) = m i n \left(\left|{N}_{0} \left(I\right)\right| , δ\right)$$

where min(a,b) refers to the smaller one of a and b; δ is a hyperparameter and refers to the foregoing target threshold, configured to limit the maximum value of the noise feature value; and the smaller the value of δ , the lower the noise generated, the less easily it is perceived by human eyes after being superimposed on the original image, and the better the quality of the final generated attack image.

The second feature map is denoted by the symbol N in this embodiment of this disclosure, and the second feature map of the original image I is represented as N(I). N₀ denotes the original noise feature map, so N₀(I) in the foregoing formula denotes the original noise feature map of the original image I. In addition, a size of the second feature map is consistent with a size of the original image. In addition, the second feature map is noise to be superimposed on the original image, that is, an image disturbance.

The foregoing step 2022 is an exemplary step, that is, the server may use the original noise feature map in the foregoing step 2021 as a second feature map, and may alternatively use the original noise feature map after noise suppression in the foregoing step 2022 as a second feature map. This embodiment of this disclosure does not specifically limit whether to suppress noise.

In step 2023, the server inputs the first feature map into a second feature decoder of an adversarial attack network for second feature-decoding, to obtain the third feature map of the original image.

The foregoing step 2023 is that the server inputs the first feature map into a second feature decoder of an adversarial attack network, and feature-decodes the first feature map through the second feature decoder to output the third feature map. Positions on the third feature map have different feature values, and each feature value is used for representing the importance of an image feature at a corresponding position.

In some embodiments, the second feature decoder 303 includes a deconvolutional layer and a convolutional layer. The convolutional layer is located after the deconvolutional layer in connection order, that is to say, a feature map outputted from the deconvolutional layer is inputted into the convolutional layer as an input signal for convolution.

In an example, as shown in FIG. 4, a structure of the second feature decoder 303 and a structure of the first feature decoder 302 are the same. That is, a structure of the salient region decoder is the same as a structure of the noise decoder, and is also composed of two 3x3 deconvolutional layers and a 7x7 convolutional layer. The input of the salient region decoder is also the output (e.g., the first feature map) of the first feature encoder 301, and the output of the salient region decoder is the salient region feature map (e.g., the third feature map) of the original image. Specifically, as shown in FIG. 4, a feature map inputted by the first feature decoder 302 is a w/4*h/4* 128 first feature map obtained after encoding by the feature encoder 301, and the first feature map becomes a w/2*h/2*64 feature map after passing the first 3x3 deconvolutional layer of the second feature decoder 303; after passing the second 3x3 deconvolutional layer, the feature map becomes a w*h*32 feature map; and then after the feature map passes a 7x7 convolutional layer, a w*h*1 feature map is obtained, that is, a salient region feature map (e.g., the third feature map).

In step 2024, the server performs normalization processing on an image feature value at each position on the third feature map.

A size of the third feature map is consistent with a size of the original image, and is denoted by the symbol M in this specification.

The motivation for designing the salient region decoder is that for a neural network, some regions in the input image are very important, while other regions are relatively unimportant. Therefore, this specification uses the second feature decoder to decode the input feature (the first feature map) to obtain a feature map M, which is called salient region feature map. Then, the image feature value at each position on the feature map is normalized to a range of [0,1].

In step 203, the server generates a noise image, based on the second feature map and the third feature map.

In some embodiments, the generating a noise image, based on the second feature map and the third feature map includes, but is not limited to: performing position-wise multiplication on the second feature map obtained after processing in step 2022 and the third feature map obtained after processing in step 2024, to obtain a noise image.

Both the second feature map and the third feature map keep the same size as the original image, which means that both the second feature map and the third feature map are the same in size, so the meaning of the foregoing “position-wise multiplication” refers to: for any position in the second feature map, a same position may be found in the third feature map, and the noise feature value at this position in the second feature map is multiplied by the image feature value at the same position in the third feature map to obtain a pixel value at the same position in the noise image. The foregoing operations are repeated, and a noise image with the same size as the original image may be finally obtained.

The larger the image feature value at any position on the salient region feature map, the more important the image feature at that position is, and the greater the probability that the noise feature value at the corresponding position is retained. In this way, the noise is more concentrated in the important region of the image to improve the attack success rate.

In step 204, the server superimposes the original image and the noise image, to obtain a first adversarial example (or first adversarial example image).

In some embodiments, referring to FIG. 3 and FIG. 4, an adversarial example of the original image I is obtained by performing position-wise superimposition on the original image I and a noise image P. The adversarial example is called first adversarial example in this specification and is denoted by symbol Iʹ.

Since a size of the noise image is consistent with that of the original image, the meaning of the foregoing “position-wise superimposition” refers to: for any position in the original image, a same position may be found in the noise image, and the pixel value at this position in the original image is added to the pixel value at the same position in the noise image to obtain a pixel value at the same position in the first adversarial example. The foregoing operations are repeated, and a first adversarial example with the same size as the original image may be finally obtained.

The original image is visually consistent with the first adversarial example, that is, after adding disturbances that are difficult to be detected by human eyes to the original image to obtain the first adversarial example, the original image and the first adversarial example appear to be consistent to human eyes, and human eyes cannot distinguish the subtle differences between them. However, the original image and the first adversarial example are physically inconsistent, that is, compared with the original image, the first adversarial example includes not only all the image information of the original image, but also noise that is difficult for human eyes to recognize; in other words, the first adversarial example includes all the image information of the original image and noise information that is difficult for human eyes to recognize.

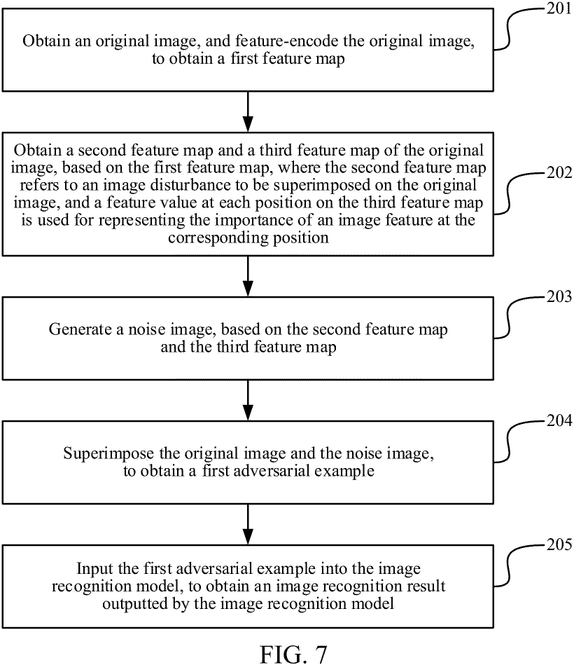

Further, referring to FIG. 3 and FIG. 4, the adversarial attack network further includes an image recognition model 304. After the first adversarial example is obtained, referring to FIG. 7, the method provided in the embodiments of this disclosure further includes the following step 205.

In step 205, the server inputs the first adversarial example into the image recognition model, to obtain an image recognition result outputted by the image recognition model.

In an example, after the first adversarial example Iʹ is obtained, the first adversarial example Iʹ is inputted into an image recognition model to be attacked, and then is configured to attack the image recognition model.

The image processing solution provided in an embodiment of this disclosure may generate the adversarial example only by one forward operation. Specifically, after the first feature map is obtained by feature extraction of the original image, the second feature map and the third feature map of the original image are obtained based on the first feature map; and the second feature map refers to an image disturbance to be superimposed on the original image and difficult to be recognized by human eyes, positions on the third feature map have different feature values, and each feature value is used for representing the importance of an image feature at a corresponding position. Then, a noise image is generated based on the second feature map and the third feature map, and then the original image and the noise image are superimposed to obtain an adversarial example. This image processing method may quickly generate the adversarial example, so timeliness is relatively good. In addition, the generated disturbance is stable, and the existence of the third feature map may make the noise more concentrated in important regions (salient region), make the generated adversarial example higher in quality, and then more effectively improve the attack effect on the image recognition model.

Accordingly, embodiments of this disclosure may achieve a good attack effect during adversarial attacks. In terms of application, after using the adversarial example generated in this embodiment of this disclosure to attack the image recognition model to further train the image recognition model, the resistance of the image recognition model in the face of the adversarial attacks may be effectively improved, that is, the image processing solution may be used as a data enhancement method to optimize an image recognition model, thereby improving the classification accuracy of the image recognition model.

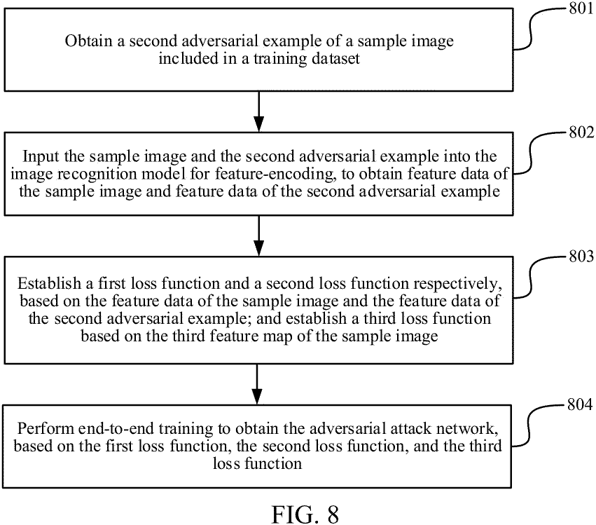

In some other embodiments, during the training stage, referring to FIG. 8, the foregoing training process of the adversarial attack network is performed by the training device 110 in the foregoing implementation environment. Using an example that the training device is a server for description, the training process includes, but is not limited to, the following steps.

In step 801, the server obtains a second adversarial example of a sample image included in a training dataset.

In an embodiment of this disclosure, adversarial examples of the sample image are collectively referred to as an second adversarial example. In addition, the training dataset includes a plurality of sample images, and each sample image corresponds to an adversarial example, that is, the number of second adversarial examples is also more than one.

In an example, similar to the image processing process shown in the foregoing steps 201 to 204, for any sample image, obtaining the second adversarial example of the sample image includes, but is not limited to, the following substeps:

In a first sub-step, the server feature-encodes the sample image through the feature encoder 301 of the adversarial attack network to obtain the first feature map of the sample image. For the detailed implementation, refer to the foregoing step 201.

In a second sub-step, the server inputs the first feature map of the sample image into the first feature decoder 302 and the second feature decoder 303 of the adversarial attack network respectively.

In a third sub-step, the server feature-decodes the first feature map of the sample image through the first feature decoder 303, to obtain an original noise feature map of the sample image; and performs the suppression processing on a noise feature value at each position on the original noise feature map of the sample image to obtain a second feature map of the sample image.

In a fourth sub-step, the server feature-decodes the first feature map of the sample image through the second feature decoder 303 to obtain the third feature map of the sample image, and performs normalization processing on an image feature value at each position on the third feature map of the sample image.

For an exemplary implementation of the second through fourth sub-steps, refer to the foregoing step 202.

In a fifth sub-step, the server generates a noise image of the sample image, based on the second feature map and the third feature map of the sample image; and superimposes the sample image on the noise image of the sample image, to obtain a second adversarial example of the sample image.

For an exemplary implementation of the fifth sub-step, refer to the foregoing step 203 and step 204.

In step 802, the server inputs the sample image and the second adversarial example into the image recognition model for feature-encoding, to obtain feature data of the sample image and feature data of the second adversarial example.

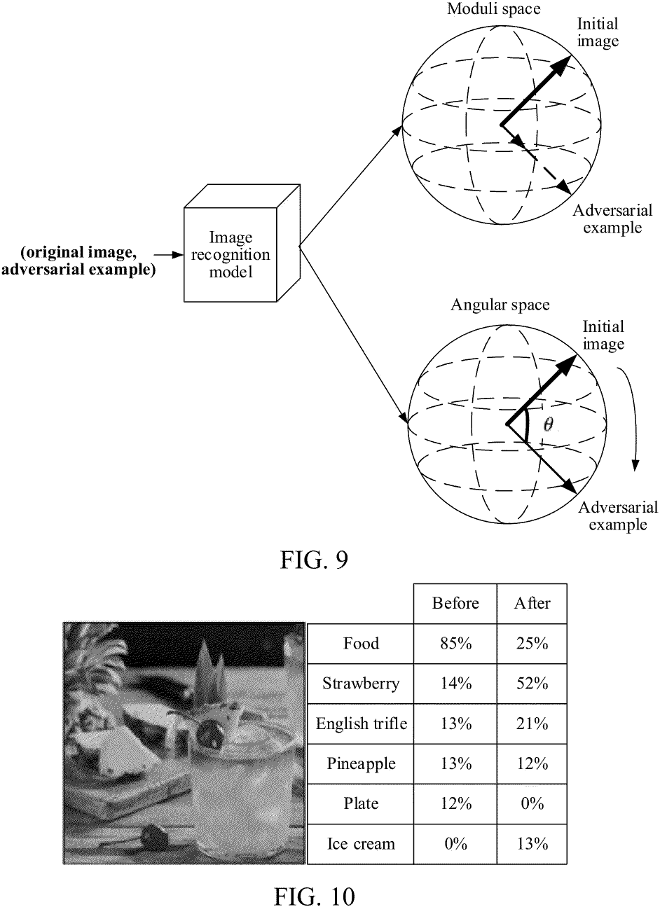

Referring to FIG. 9, during the training stage, step 802 is that the initial image and the corresponding adversarial example are inputted into the image recognition model that needs to be attacked for feature extraction to obtain feature data.

In step 803, the server establishes a first loss function and a second loss function respectively, based on the feature data of the sample image and the feature data of the second adversarial example; and establishes a third loss function, based on the third feature map of the sample image.

In other words, a first loss function value and a second loss function value are obtained respectively based on the feature data of the sample image and the feature data of the second adversarial example; and a third loss function value is obtained based on the third feature map of the sample image.

For a neural network, the feature angle is the main factor affecting the image classification result, and the feature modulus value is the main factor affecting the image change extent. Therefore, referring to FIG. 9, examples may be based on an angular-modular isolation and optimization loss function. That is, in an embodiment of this disclosure, the feature angle and the feature modulus value are considered separately, and two loss functions are designed, which are respectively

$${L}_{a n g u l a r}$$

and

$${L}_{n o r m}$$

. As shown in FIG. 9, for a moduli space (the high-dimensional space is simulated as a sphere),

$${L}_{n o r m}$$

attempts to bring the feature modulus value of the initial image closer to the feature modulus value of the corresponding adversarial example. For example, the loss function is configured to bring the feature modulus value of the adversarial example as close as possible to be consistent with the feature modulus value of the initial image. For an angular space (the high-dimensional space is simulated as a sphere),

$${L}_{a n g u l a r}$$

attempts to increase the angle θ between the feature of the initial image and the feature of the corresponding adversarial example. In this way, the image classification result may be changed as much as possible without changing the appearance of the inputted initial image.

Establishing a first loss function and a second loss function respectively, based on the feature data of the sample image and the feature data of the second adversarial example includes, but is not limited to, the following sub-steps:

In a first sub-step, the server isolates, from the feature data of the sample image, a feature angle of the sample image; and isolates, from the feature data of the second adversarial example, a feature angle of the second adversarial example.

In a second sub-step, the server establishes the first loss function, based on the feature angle of the sample image and the feature angle of the second adversarial example, where an optimization objective of the first loss function is to increase a feature angle between the sample image and the second adversarial example.

In other words, the first loss function value is obtained based on the feature angle of the sample image and the feature angle of the second adversarial example, where an optimization objective of the first loss function value is to increase a feature angle between the sample image and the second adversarial example. For example, the cosine value of the angle between the feature vectors of the sample image and the second adversarial example in the angular space is used as the first loss function value.

In a third sub-step, the server establishes the second loss function, based on the feature modulus value of the sample image and the feature modulus value of the second adversarial example, where an optimization objective of the second loss function is to reduce a difference between the feature modulus value of the sample image and the feature modulus value of the second adversarial example.

In other words, the second loss function value is obtained based on the feature modulus value of the sample image and the feature modulus value of the second adversarial example, where an optimization objective of the second loss function value is to reduce a difference between the feature modulus value of the sample image and the feature modulus value of the second adversarial example. For example, the difference between the modulus values of the feature vectors of the sample image and the second adversarial example in the moduli space is used as the second loss function value.

In an example, the first loss function and the second loss function are defined as follows:

$$L {}_{a n g u l a r} = {\sum }_{i = 1}^{i} \left(1 + \frac{Γ \left({I}_{i}\right) ⋅ Γ \left({I}_{i} + P \left({I}_{i}\right)\right)}{m a x \left(\left‖Γ \left({I}_{i}\right) \left‖⋅\right‖ Γ \left({I}_{i} + P \left({I}_{i}\right)\right) \left‖, ∈\right)\right)\right)}\right)$$

$$L {}_{n o r m} = {{\sum }_{i = 1}^{j} \left(\left‖Γ \left({I}_{i}\right)\right‖ - \left‖Γ \left({I}_{i} + P \left({I}_{i}\right)\right)\right‖\right)}^{2}$$

where the values of j are all positive integers, j refers to the number of sample images included in the training dataset, and i is a positive integer greater than or equal to 1 and less than or equal to j; Γ refers to the network parameter of the image recognition model; Iᵢ refers to the i^{th} sample image in the training dataset, and P(Iᵢ) refers to a noise image of Iᵢ ; Iᵢ + P(Iᵢ) refers to an adversarial example of Iᵢ; and ∈ is a hyperparameter.

In an example, the third loss function is defined as follows:

$${L}_{f} = {\sum }_{i = 1}^{i} \sqrt{t r \left(M {\left({I}_{i}\right)}^{T} M \left({i}_{i}\right)\right)}$$

M(Iᵢ) refers to a salient region feature map of Iᵢ ; tr refers to a trace of a matrix; the function of ℒ_{ƒ} is to make the salient region more concentrated; and T refers to a rank of the matrix.

The trace of the matrix is defined as: a sum of the elements on the main diagonal (diagonal from the upper left to the lower right) of an n×n matrix A is called the trace of the matrix A and is denoted as tr(A).

In an example, after the salient region feature map (the third feature map) of the sample image is obtained, the third loss function value is obtained based on the third feature map of the sample image.

In step 804, the server performs end-to-end training to obtain the adversarial attack network, based on the first loss function, the second loss function, and the third loss function.

In other words, the server performs end-to-end training on an initial adversarial attack network to obtain the adversarial attack network, based on the first loss function value, the second loss function value, and the third loss function value. Structures of the initial adversarial attack network and the adversarial attack network are the same. The training process of the initial adversarial attack network refers to the process of constantly optimizing and adjusting the parameters of the initial adversarial attack network. In a case that the training of the initial adversarial attack network is stopped, the adversarial attack network with the required performance meeting the use requirements is obtained.

In an example, the performing end-to-end training on an initial adversarial attack network to obtain the adversarial attack network, based on the first loss function value, the second loss function value, and the third loss function value includes, but is not limited to: obtaining a first sum value of the second loss function value and the third loss function value; obtaining a product value of a target constant and the first sum value; and taking a second sum value of the first loss function value and the product value as a final loss function value, and performing the end-to-end training on the initial adversarial attack network to obtain the adversarial attack network.

In an example, the foregoing final loss function value may be expressed as the following formula:

$$L = {L}_{a n g u l a r} + α \left({L}_{n o r m} + {L}_{f}\right)$$

,where α refers to a target constant.

According to the defined loss function, the initial adversarial attack network is trained end to end, an automatic encoder for adversarial attacks may be obtained, and then the adversarial example of the inputted original image is generated by using the automatic encoder and then is used to attack the image recognition model.

In the training process of the adversarial attack network, an embodiment of this disclosure is based on an angular-modular isolation and optimization loss function, and the image classification result may be changed as much as possible without changing the appearance of the original image or the initial image. That is, the generated adversarial example is of higher quality, which is not only more consistent with the original image or the initial image in appearance, but also may achieve a better attack effect, and the image recognition model that is not easy to be attacked may be correctly classified.

Application scenarios of the image processing solution provided in an embodiment of this disclosure are described below.

The adversarial example generated based on the automatic encoder may improve the resistance of the image recognition model in the face of the adversarial attacks, so the image processing solution provided in this embodiment of this disclosure may be used as a data enhancement method to optimize an image recognition model, thereby improving the classification accuracy of the image recognition model. For example, this image processing solution achieves an effective attack effect in a plurality of recognition tasks, and even can also achieve a good attack effect in black box attacks.

Example 1. In the field of target recognition, the image processing solution provided in this embodiment of this disclosure is used as a data enhancement method to optimize a target recognition model, thereby improving the classification accuracy of the target recognition model for the specified target. This is of great significance in scenarios such as security check, identity verification or mobile payment.

Example 2. In the field of item recognition, the image processing solution provided in this embodiment of this disclosure is used as a data enhancement method to optimize an item recognition model, thereby improving the classification accuracy of the item recognition model. In an example, this is of great significance in the circulation of goods, especially in the field of unmanned retail such as unmanned shelves and intelligent retail cabinets.

In addition, the image processing solution provided in this embodiment of this disclosure may also attack some image recognition online tasks, so as to verify the attack resistance of the image recognition online tasks.

The application scenarios described above are merely used as examples rather than limiting the embodiments of this disclosure. During actual implementation, technical solutions provided in embodiments of this disclosure may be flexibly applied according to actual requirements.

The attack effect of the image processing solution provided in an embodiment of this disclosure is described below through FIG. 10 to FIG. 14.

Referring to FIG. 10, the left figure in FIG. 10 is an example picture, and the right figure in FIG. 10 is an image recognition result obtained by attacking an image recognition online service. As shown in FIG. 10, for the original image, the probability of being recognized as “food” by the image recognition online service is up to 85%; and after an adversarial example of the original image is generated based on the image processing method provided in this embodiment of this disclosure, the probability that the adversarial example is recognized as “food” by the image recognition online service drops sharply to 25%.

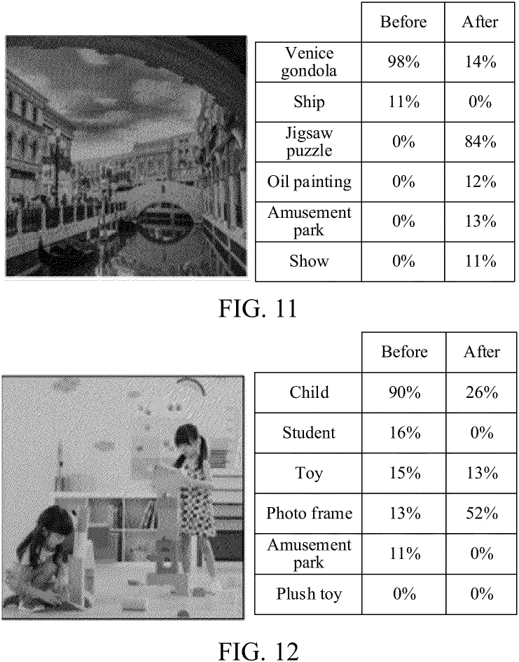

Referring to FIG. 11, the left figure in FIG. 11 is an example picture, and the right figure in FIG. 11 is an image recognition result obtained by attacking an image recognition online service. As shown in FIG. 11, for the original image, the probability of being recognized as “Venice gondola” by the image recognition online service is up to 98%; and after an adversarial example of the original image is generated based on the image processing method provided in this embodiment of this disclosure, the probability that the adversarial example is recognized as “Venice gondola” by the image recognition online service drops sharply to 14%. On the contrary, the probability of being recognized as “jigsaw puzzle” has increased from 0% to 84%.

Referring to FIG. 12, the left figure in FIG. 12 is an example picture, and the right figure in FIG. 12 is an image recognition result obtained by attacking an image recognition online service. As shown in FIG. 12, for the original image, the probability of being recognized as “child” by the image recognition online service is up to 90%; and after an adversarial example of the original image is generated based on the image processing method provided in this embodiment of this disclosure, the probability that the adversarial example is recognized as “child” by the image recognition online service drops sharply to 14%. On the contrary, the probability of being recognized as “photo frame” has increased from 13% to 52%.

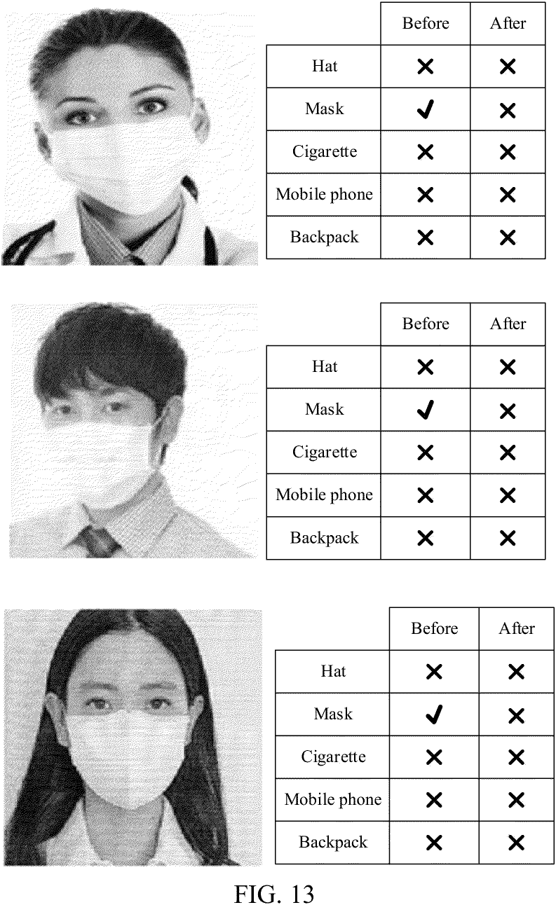

Referring to FIG. 13, the left column in FIG. 13 is an example picture, and the right column in FIG. 13 is an image recognition result obtained by attacking an image recognition online service. As shown in FIG. 13, before the adversarial attack processing, three images in the left column are each recognized as “mask”, but after the adversarial attack processing, none of the three images in the left column is recognized as “mask”.

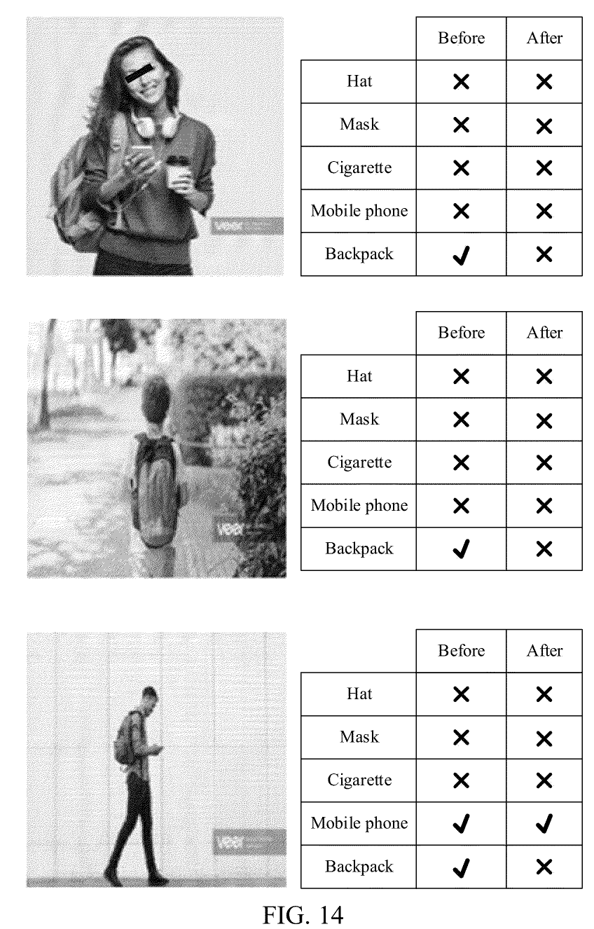

Referring to FIG. 14, the left column in FIG. 14 is an example picture, and the right column in FIG. 14 is an image recognition result obtained by attacking an image recognition online service. As shown in FIG. 14, before the adversarial attack processing, three images in the left column are each recognized as “backpack”, but after the adversarial attack processing, none of the three images in the left column is recognized as “backpack”.

Accordingly, with reference to the image recognition results shown in FIG. 10 to FIG. 14, it can be learned that after the image processing solution provided in this embodiment of this disclosure generates the adversarial example and attacks the image recognition online service, the image recognition accuracy of the image recognition online service for the generated adversarial example may be greatly reduced, and image classification errors occur. For example, the image shown in FIG. 13 cannot be recognized as “mask”, and in another example, the image shown in FIG. 14 cannot be recognized as “backpack”, which intuitively shows that the image processing solution provided in this embodiment of this disclosure has a good attack effect during adversarial attacks. Further, in terms of application, the image processing solution provided in this embodiment of this disclosure is used as a data enhancement method to optimize the image recognition model or image recognition service, and then is configured to improve the classification accuracy of an image recognition model or image recognition service.

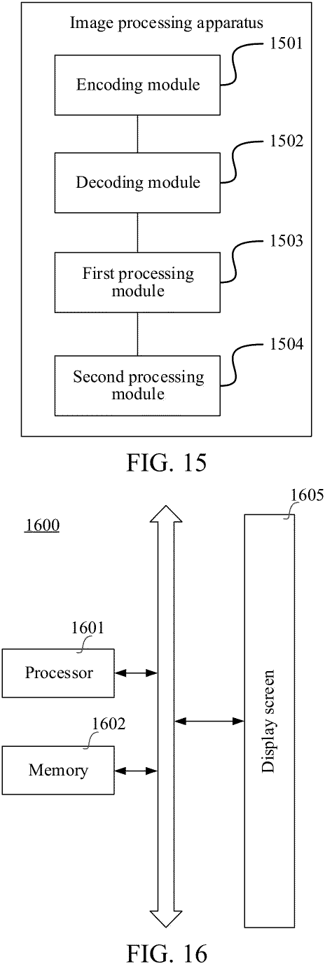

FIG. 15 is a schematic structural diagram of an image processing apparatus according to an embodiment of this disclosure. Referring to FIG. 15, the apparatus includes an encoding module 1501, a decoding module 1502, a first processing module 1503, and a second processing module 1504. One or more modules, submodules, and/or units of the apparatus can be implemented by processing circuitry, software, or a combination thereof, for example.

The encoding module 1501 is configured to obtain an original image, and feature -encode the original image, to obtain a first feature map.

The decoding module 1502 is configured to obtain a second feature map and a third feature map of the original image, based on the first feature map, where the second feature map refers to an image disturbance to be superimposed on the original image, positions on the third feature map have different feature values, and each feature value is used for representing the importance of an image feature at a corresponding position.

The first processing module 1503 is configured to generate a noise image, based on the second feature map and the third feature map.

The second processing module 1504 is configured to superimpose the original image and the noise image, to obtain a first adversarial example.

The image processing solution provided in an embodiment of this disclosure may generate the adversarial example only by one forward operation. Specifically, after the first feature map is obtained by feature-encoding the original image, the second feature map and the third feature map of the original image are obtained based on the first feature map; and the second feature map refers to an image disturbance to be superimposed on the original image and difficult to be recognized by human eyes, positions on the third feature map have different feature values, and each feature value is used for representing the importance of an image feature at a corresponding position. Then, a noise image is generated based on the second feature map and the third feature map, and then the original image and the noise image are superimposed to obtain an adversarial example. This image processing method may quickly generate the adversarial example, so timeliness is relatively good. In addition, the generated disturbance is stable, and the existence of the third feature map may make the noise more concentrated in important regions, make the generated adversarial example higher in quality, and then effectively improve the attack effect.

Accordingly, the embodiments of this disclosure may achieve the good attack effect during adversarial attacks. In terms of application, this embodiment of this disclosure may effectively improve the resistance of the image recognition model in the face of the adversarial attacks, that is, the image processing solution may be used as a data enhancement method to optimize an image recognition model, thereby improving the classification accuracy of the image recognition model.

In some embodiments, the encoding module 1501 is configured to: input the original image into a feature encoder of an adversarial attack network for feature-encoding, to obtain the first feature map, a size of the first feature map being less than a size of the original image, where the feature encoder includes a convolutional layer and a ResBlock, the ResBlock is located after the convolutional layer in connection order, each ResBlock includes an identity mapping and at least two convolutional layers, and the identity mapping of the ResBlock points to an output end of the ResBlock from an input end of the ResBlock.

In some embodiments, the decoding module 1502 includes a first decoding unit, and the first decoding unit is configured to: input the first feature map into a first feature decoder of an adversarial attack network for feature-decoding, to obtain an original noise feature map; and perform suppression processing on a noise feature value at each position on the original noise feature map to obtain the second feature map, a size of the second feature map being consistent with a size of the original image, where the first feature decoder includes a deconvolutional layer and a convolutional layer, and the convolutional layer is located after the deconvolutional layer in connection order.

In some embodiments, the decoding module 1502 includes a first decoding unit, and the first decoding unit is configured to: compare the noise feature value at each position on the original noise feature map with a target threshold; and replace, for any position on the original noise feature map, a noise feature value of the position with a target threshold in a case that the noise feature value of the position is greater than the target threshold.

In some embodiments, the decoding module 1502 further includes a second decoding unit, and the second decoding unit is configured to: input the first feature map into a second feature decoder of an adversarial attack network for feature-decoding, to obtain the third feature map of the original image; and perform normalization processing on an image feature value at each position on the third feature map, a size of the third feature map being consistent with a size of the original image, where the second feature decoder includes a deconvolutional layer and a convolutional layer, and the convolutional layer is located after the deconvolutional layer in connection order.

In some embodiments, the first processing module 1503 is configured to perform position-wise multiplication on the second feature map and the third feature map, to obtain the noise image.

In some embodiments, the adversarial attack network further includes an image recognition model; the apparatus further includes: a classification module; and the classification module is configured to input the first adversarial example into the image recognition model, to obtain an image recognition result outputted by the image recognition model.

In some embodiments, a training process of the adversarial attack network includes: obtaining a second adversarial example of a sample image included in a training dataset; inputting the sample image and the second adversarial example into the image recognition model for feature-encoding, to obtain feature data of the sample image and feature data of the second adversarial example; obtaining a first loss function value and a second loss function value respectively, based on the feature data of the sample image and the feature data of the second adversarial example; obtaining a third feature map of the sample image, positions on the third feature map of the sample image having different feature values, and each feature value being used for representing the importance of an image feature at a corresponding position; obtaining a third loss function value, based on the third feature map of the sample image; and performing end-to-end training on an initial adversarial attack network to obtain the adversarial attack network, based on the first loss function value, the second loss function value, and the third loss function value.

In some embodiments, a training process of the adversarial attack network includes: isolating, from the feature data of the sample image, a feature angle of the sample image; isolating, from the feature data of the second adversarial example, a feature angle of the second adversarial example; and obtaining the first loss function value, based on the feature angle of the sample image and the feature angle of the second adversarial example, an optimization objective of the first loss function value being to increase a feature angle between the sample image and the second adversarial example.

In some embodiments, a training process of the adversarial attack network includes: isolating, from the feature data of the sample image, a feature modulus value of the sample image; isolating, from the feature data of the second adversarial example, a feature modulus value of the second adversarial example; and obtaining the second loss function value, based on the feature modulus value of the sample image and the feature modulus value of the second adversarial example, an optimization objective of the second loss function value being to reduce a difference between the feature modulus value of the sample image and the feature modulus value of the second adversarial example.

In some embodiments, a training process of the adversarial attack network includes: obtaining a first sum value of the second loss function value and the third loss function value; obtaining a product value of a target constant and the first sum value; and taking a second sum value of the first loss function value and the product value as a final loss function value, and performing the end-to-end training on the initial adversarial attack network to obtain the adversarial attack network.

In some embodiments, structures of the first feature decoder and the second feature decoder of the adversarial attack network are the same.

All of the above exemplary technical solutions may be combined in various manners to form other embodiments of this disclosure. Details are not described herein again.

The division of the foregoing functional modules is merely used as an example for description when the image processing apparatus provided in the foregoing embodiments performs image processing. In practical application, the foregoing functions may be allocated to and completed by different functional modules according to requirements, that is, an inner structure of an apparatus is divided into different functional modules to implement all or a part of the functions described above. In addition, the image processing apparatus provided in the foregoing embodiment belongs to the same idea as the image processing method. See the method embodiment for an exemplary implementation process thereof, and details are not described herein again.

The term module (and other similar terms such as unit, submodule, etc.) in this disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

FIG. 16 is a structural block diagram of a computer device 1600 according to an exemplary embodiment of this disclosure. Using an example that the computer device is a terminal, generally, the computer device 1600 includes: a processor 1601 and a memory 1602.

Processing circuitry, such as the processor 1601, may include one or more processing cores, for example, may be a 4-core processor or an 8-core processor. The processor 1601 may be implemented by at least one hardware form in a digital signal processor (DSP), a field -programmable gate array (FPGA), and a programmable logic array (PLA). The processor 1601 includes a main processor and a coprocessor. The main processor is configured to process data in an active state, also referred to as a central processing unit (CPU). The coprocessor is a low-power consumption processor configured to process data in a standby state. In some embodiments, the processor 1601 may be integrated with a graphics processing unit (GPU). The GPU is configured to render and draw content that needs to be displayed on a display screen. In some embodiments, the processor 1601 may further include an artificial intelligence (AI) processor. The AI processor is configured to process a computing operation related to machine learning.

The memory 1602 may include one or more computer-readable storage media. The computer-readable storage media may be non-transitory. The memory 1602 may also include a high-speed random access memory, as well as non-volatile memory, such as one or more disk storage devices and flash storage devices. In some embodiments, a non-transitory computer-readable storage medium in the memory 1602 is configured to store at least one piece of program code, the at least one piece of program code being configured to be executed by the processor 1601 to implement the image processing method provided in the method embodiments of this disclosure.

In some embodiments, the computer device 1600 may further include: a display screen 1605.

The display screen 1605 is configured to display a user interface (UI). The UI may include a graph, a text, an icon, a video, and any combination thereof. When the display screen 1605 is a touch display screen, the display screen 1605 also has the ability to collect a touch signal at or above the surface of the display screen 1605. The touch signal may be inputted, as a control signal, to the processor 1601 for processing. In this case, the display screen 1605 may also be configured to provide virtual buttons and/or virtual keyboards, also referred to as soft buttons and/or soft keyboards. In some embodiments, there may be one display screen 1605, disposed on a front panel of the computer device 1600; in some other embodiments, there may be at least two display screens 1605, disposed on different surfaces of the computer device 1600 respectively or in a folded design; and in still other embodiments, the display screen 1605 may be a flexible display screen, disposed on a curved surface or a folded surface of the computer device 1600. Even further, the display screen 1605 may be arranged in a non-rectangular irregular pattern, that is, a special-shaped screen. The display screen 1605 may be made of materials such as liquid crystal display (LCD) and organic light-emitting diode (OLED).

A person skilled in the art may understand that the structure shown in FIG. 16 does not constitute any limitation on the computer device 1600, and the computer device may include more components or fewer components than those shown in the figure, or some components may be combined, or a different component deployment may be used.

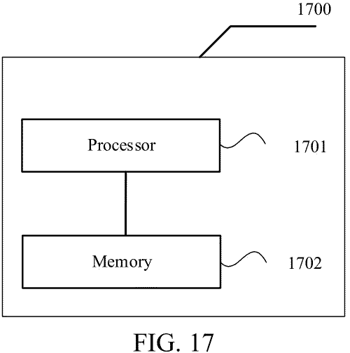

FIG. 17 is a schematic structural diagram of a computer device according to an embodiment of this disclosure. Using an example that the computer device is a server, the server 1700 may vary greatly due to different configurations or performance, and may include one or more processors (e.g., central processing units (CPUs)) 1701 and one or more memories 1702. The memory 1702 stores at least one piece of program code, the at least one piece of program code being loaded and executed by the processor 1701 to implement the image processing method provided in the foregoing method embodiments. The server may further include components such as a wired or wireless network interface, a keyboard, and an input/output interface, to facilitate inputs/outputs. The server may further include another component configured to implement functions of a device. Details are not described herein again.

In an exemplary embodiment, a computer-readable storage medium, for example, a memory including program code is further provided. The foregoing program code may be executed by a processor in a computer device to implement the image processing method in the foregoing embodiments. For example, the computer-readable storage medium may be a read-only memory (ROM), a random access memory (random-access memory, RAM), a compact disc read-only memory (CD-ROM), a magnetic tape, a floppy disk, an optical data storage device, and the like.

In an exemplary embodiment, a computer program product or a computer program is provided, including computer program code, the computer program code being stored in a computer-readable storage medium, a processor of a computer device reading the computer program code from the computer-readable storage medium, and the processor executing the computer program code, to cause the computer device to implement the foregoing image processing method.

A person of ordinary skill in the art may understand that all or some of the steps of the foregoing embodiments may be implemented by hardware, or may be implemented by a program instructing relevant hardware. The program may be stored in a computer-readable storage medium. The storage medium may be a read-only memory, a magnetic disk, an optical disc, or the like.

The foregoing descriptions are merely exemplary embodiments of this disclosure, but are not intended to limit this disclosure. Any modification, equivalent replacement, or improvement made within the spirit and principle of this disclosure shall fall within the protection scope of this disclosure.

What is claimed is:

1. An image processing method, comprising:
obtaining a first feature map based on feature-encoding of an original image;
obtaining a second feature map of the original image based on the first feature map, the second feature map including noise information to be superimposed on the original image;
obtaining a third feature map of the original image based on the first feature map, the third feature map including different feature values, and each feature value representing a relative importance of an image feature at a position corresponding to the respective feature value;
generating, by processing circuitry, a noise image based on the second feature map and the third feature map; and
superimposing the original image and the noise image, to obtain a first adversarial example image.

2. The method according to claim 1, wherein the obtaining the first feature map comprises:
inputting the original image into a feature encoder of an adversarial attack network for the feature-encoding, to obtain the first feature map, a size of the first feature map being less than a size of the original image, the feature encoder including a convolutional layer and a residual block (ResBlock) that is located after the convolutional layer in connection order, each ResBlock including an identity mapping and at least two convolutional layers, and the identity mapping of the ResBlock pointing to an output end of the ResBlock from an input end of the ResBlock.

3. The method according to claim 1, wherein the obtaining the second feature map comprises:
inputting the first feature map into a first feature decoder of an adversarial attack network for feature-decoding, to obtain an original noise feature map, the first feature decoder including a deconvolutional layer and a convolutional layer that is located after the deconvolutional layer in connection order; and
performing suppression processing on a noise feature value at each of a plurality of positions on the original noise feature map to obtain the second feature map, a size of the second feature map being equal to a size of the original image.

4. The method according to claim 3, wherein the performing the suppression processing comprises:
replacing a noise feature value of each of the plurality of positions with a target threshold when the noise feature value of the respective position is greater than the target threshold.

5. The method according to claim 1, wherein the obtaining the third feature map comprises:
inputting the first feature map into a second feature decoder of an adversarial attack network for feature-decoding, to obtain the third feature map, the second feature decoder including a deconvolutional layer and a convolutional layer that is located after the deconvolutional layer in connection order; and
performing normalization processing on an image feature value at each of a plurality of positions on the third feature map, a size of the third feature map being equal to a size of the original image.

6. The method according to claim 1, wherein the generating the noise image comprises:
generating the noise image based on a position-wise multiplication on the second feature map and the third feature map.

7. The method according to claim 2, further comprising:
inputting the first adversarial example image into an image recognition model of the adversarial attack network; and
obtaining an image recognition result of the first adversarial example image from the image recognition model.

8. The method according to claim 7, further comprising:
training the adversarial attack network, the training including:
obtaining a second adversarial example image of a sample image included in a training dataset;
inputting the sample image and the second adversarial example image into the image recognition model for feature-encoding, to obtain feature data of the sample image and feature data of the second adversarial example image;
obtaining a first loss function value and a second loss function value based on the feature data of the sample image and the feature data of the second adversarial example image;
obtaining a third feature map of the sample image, the third feature map of the sample image including different feature values, and each feature value of the third feature map representing a relative importance of an image feature at a position corresponding to the respective feature value;
obtaining a third loss function value based on the third feature map of the sample image; and
performing end-to-end training on an initial adversarial attack network to obtain the adversarial attack network based on the first loss function value, the second loss function value, and the third loss function value.

9. The method according to claim 8, wherein the obtaining the first loss function value comprises:
isolating, from the feature data of the sample image, a feature angle of the sample image;
isolating, from the feature data of the second adversarial example image, a feature angle of the second adversarial example image; and
obtaining the first loss function value based on the feature angle of the sample image and the feature angle of the second adversarial example image, an optimization objective of the first loss function value being to increase a feature angle between the sample image and the second adversarial example image.

10. The method according to claim 8, wherein the obtaining the second loss function value comprises:
isolating, from the feature data of the sample image, a feature modulus value of the sample image;
isolating, from the feature data of the second adversarial example image, a feature modulus value of the second adversarial example image; and
obtaining the second loss function value based on the feature modulus value of the sample image and the feature modulus value of the second adversarial example image, an optimization objective of the second loss function value being to reduce a difference between the feature modulus value of the sample image and the feature modulus value of the second adversarial example image.

11. The method according to claim 8, wherein the performing the end-to-end training comprises:
obtaining a first sum value of the second loss function value and the third loss function value;
obtaining a product value of a target constant and the first sum value;
determining a second sum value of the first loss function value and the product value as a final loss function value; and
performing the end-to-end training on the initial adversarial attack network to obtain the adversarial attack network.

12. The method according to claim 7, wherein
the obtaining the second feature map includes inputting the first feature map into a first feature decoder of the adversarial attack network for feature-decoding; and
the obtaining the third feature map includes inputting the first feature map into a second feature decoder of the adversarial attack network for feature-decoding, the first feature decoder and the second feature decoder of the adversarial attack network having a same structure.

13. An image processing apparatus, comprising:
processing circuitry configured to:
obtain a first feature map based on feature-encoding of an original image;
obtain a second feature map of the original image based on the first feature map, the second feature map including noise information to be superimposed on the original image;
obtain a third feature map of the original image based on the first feature map, the third feature map including different feature values, and each feature value representing a relative importance of an image feature at a position corresponding to the respective feature value;
generate a noise image based on the second feature map and the third feature map; and
superimpose the original image and the noise image, to obtain a first adversarial example image.

14. The image processing apparatus according to claim 13, wherein the processing circuitry is configured to:
input the original image into a feature encoder of an adversarial attack network for the feature-encoding, to obtain the first feature map, a size of the first feature map being less than a size of the original image, the feature encoder including a convolutional layer and a residual block (ResBlock) that is located after the convolutional layer in connection order, each ResBlock including an identity mapping and at least two convolutional layers, and the identity mapping of the ResBlock pointing to an output end of the ResBlock from an input end of the ResBlock.

15. The image processing apparatus according to claim 13, wherein the processing circuitry is configured to:
input the first feature map into a first feature decoder of an adversarial attack network for feature-decoding, to obtain an original noise feature map, the first feature decoder including a deconvolutional layer and a convolutional layer that is located after the deconvolutional layer in connection order; and
perform suppression processing on a noise feature value at each of a plurality of positions on the original noise feature map to obtain the second feature map, a size of the second feature map being equal to a size of the original image.

16. The image processing apparatus according to claim 15, wherein the processing circuitry is configured to:
replace a noise feature value of each of the plurality of positions with a target threshold when the noise feature value of the respective position is greater than the target threshold.

17. The image processing apparatus according to claim 13, wherein the processing circuitry is configured to:
input the first feature map into a second feature decoder of an adversarial attack network for feature-decoding, to obtain the third feature map, the second feature decoder including a deconvolutional layer and a convolutional layer that is located after the deconvolutional layer in connection order; and
perform normalization processing on an image feature value at each of a plurality of positions on the third feature map, a size of the third feature map being equal to a size of the original image.

18. The image processing apparatus according to claim 13, wherein the processing circuitry is configured to:
generate the noise image based on a position-wise multiplication on the second feature map and the third feature map.

19. The image processing apparatus according to claim 14, wherein the processing circuitry is configured to:
input the first adversarial example image into an image recognition model of the adversarial attack network; and
obtain an image recognition result of the first adversarial example image from the image recognition model.

20. A non-transitory computer-readable storage medium, storing instructions which when executed by a processor cause the processor to perform:
obtaining a first feature map based on feature-encoding of an original image;
obtaining a second feature map of the original image based on the first feature map, the second feature map including noise information to be superimposed on the original image;
obtaining a third feature map of the original image based on the first feature map, the third feature map including different feature values, and each feature value representing a relative importance of an image feature at a position corresponding to the respective feature value;
generating a noise image based on the second feature map and the third feature map; and
superimposing the original image and the noise image, to obtain a first adversarial example image.
